(19) United States
(12) Patent Application Publication
(10) Pub. No.: US 2021/0123187 A1
(43) Pub. Date: Apr. 29, 2021

(54) COATING COMPOSITION FOR PACKAGING LINER

(71) Applicant: HEWLETT-PACKARD DEVELOPMENT COMPANY, L.P., Spring, TX (US)

(72) Inventors: Fereshteh Khorrami, San Diego, CA (US); Beverly Chou, San Diego, CA (US); Xulong Fu, San Diego, CA (US); Tao Chen, San Diego, CA (US)

(21) Appl. No.: 16/604,028

(22) PCT Filed: Jul. 12, 2017
(86) PCT No.: PCT/US2017/041751

§ 371 Date: Oct. 9, 2019

(51) Int. Cl. D21H 19/38; D21H 19/40; D21H 19/46; D21H 19/58; D21H 19/60; D21H 19/64; D21H 19/74; D21H 23/04; D21H 23/24; D21H 27/10; B41M 5/00

(52) U.S. Cl. CPC D21H 19/385; D21H 19/40; D21H 19/46; D21H 19/58; D21H 19/60; B41M 5/0047; D21H 19/74; D21H 23/04; D21H 23/24; D21H 27/10; D21H 19/64

(57) ABSTRACT

An example of a coating composition for a packaging liner includes an inorganic pigment, a latex, polyvinyl alcohol in an amount ranging from greater than 2 dry wt % to about 7 dry wt %, and a fixing agent. The fixing agent is selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. This technology has become a popular way of recording images on various media surfaces (e.g., paper), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a cross-sectional view of an example of a coated liner disclosed herein, also showing (in phantom) an example of a printed liner;

FIG. 2 is a flow diagram illustrating an example of a method for producing a coated liner for corrugated packaging;

FIG. 3 is a diagram illustrating an example of a printing method for producing a printed liner; and

FIG. 4 is a diagram illustrating an example of a method for producing a corrugated paper board.

### DETAILED DESCRIPTION

High-speed inkjet printing (e.g., inkjet web or web press printing) is a technology that is well adapted for commercial and package printing. In particular, high-speed printing may be used to print images (e.g., text, graphics, etc.) on a packaging liner. Generally, the images, etc. are pre-printed onto the liner prior to the liner being wound into a roll and then integrated with other layer(s) (e.g., a backing layer including fluting medium and another liner) during a corrugation process.

During printing and winding, the pre-printed liner may be exposed to media roller(s) and dryer(s) contained within the printer. The rollers may pass over images shortly after they are printed (e.g., within a few seconds). The stress applied to the printed image by the media rollers, which may be at elevated temperatures, may damage the image by changing its gloss, optical density, and/or film uniformity. Moreover, for a frame of the print that contains both high and low ink coverage, the same amount of drying may be applied post-printing. As such, the higher coverage areas may be inadequately dried. Ink coverage and drying variations, along with varying levels of media roller cleanliness, can cause the media rollers to damage the printed image by removing pieces of the ink film and/or exposing bare media. As such, high speed printing may expose the pre-printed liner to harsh environments and conditions prior to the application of any overprint varnish (OPV), which may be added to protect the printed media.

The term “mechability,” as referred to herein, is a form of durability, and means the ability of a printed image to remain undamaged when rubbed (e.g., by media rollers) immediately after printing. Poor mechability may be exacerbated with higher printing speeds. A mechability test may simulate the previously described post-printing conditions and determine if the printed image is durable enough to withstand the media roller stress and/or dirt and the varying drying conditions.

Examples of a coating composition are disclosed herein, which improve the mechability of a packaging liner including a single layer of the coating composition. The coating composition includes an increased amount of polyvinyl alcohol (PVA) rather than latex binders and/or cross-linkers. The amount of PVA ranges from greater than 2 dry wt % to about 7 dry wt %, and it has been found that this percentage enhances the mechability performance, regardless of the print and drying speed, the ink coverage, and the dryer temperature profile. In addition to enhanced mechability, it has been found that prints formed on the packaging liner disclosed herein exhibit desirable image quality attributes, such as bleed and optical density (OD), even when printed/dried at high speeds (e.g., a printing speed ranging from about 400 feet per minute (fpm) to about 600 fpm). In the examples disclosed herein, suitable image quality attributes can also be achieved at lower print speeds, for example, below 400 fpm, at or below 100 fpm, etc. The low printing speed is dependent upon the printer limits, and any low printing speed may be used.

The coating composition may be applied to form a single layer of the packaging liner. To form a single layer, the coating composition is applied and dried in a single application, thus reducing energy and processing involved in forming the packaging liner.

In an example, the coating composition for a packaging liner comprises an inorganic pigment; a latex; polyvinyl alcohol in an amount ranging from greater than 2 dry wt % to about 7 dry wt %; and a fixing agent selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof.

As used herein, “dry wt %” refers to a component's percentage (by weight) of all the components of the coating composition prior to the addition of water or after water is removed therefrom. In other words, the dry wt % of any component is the dry parts of that component divided by the total dry parts of all the coating composition dry components multiplied by 100.

The coating composition may also include water. In some examples, the coating composition may also include additional components. Examples of additional components that may be included in the coating composition include a surfactant/dispersant, a wax, a plastic pigment, a crosslinker, or a combination thereof. In an example, the coating composition further comprises a surfactant/dispersant, a wax, a plastic pigment, a crosslinker, water, or a combination thereof.

In an example, the coating composition consists of: an inorganic pigment; a latex; polyvinyl alcohol in an amount ranging from greater than 2 dry wt % to about 7 dry wt %; a fixing agent selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof; and water. When the coating composition consists of the inorganic pigment, the latex, polyvinyl alcohol, the fixing agent, and water, the coating composition does not include any other components.

Further, in an example, the coating composition consists essentially of: an inorganic pigment; a latex; polyvinyl alcohol in an amount ranging from greater than 2 dry wt % to about 7 dry wt %; a fixing agent selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof; and water. When the coating composition consists essentially of the inorganic pigment, the latex, polyvinyl alcohol, the fixing agent, and water, the coating composition may include other components that do not materially alter or affect the formulation and/or function of the coating composition.

As mentioned above, the coating composition includes polyvinyl alcohol in an amount ranging from greater than 2 dry wt % to about 7 dry wt %. In an example, the coating composition includes polyvinyl alcohol in an amount ranging from greater than 2 dry wt % to about 5 dry wt %. In another example, the coating composition includes polyvinyl alcohol in an amount ranging from about 3 dry wt % to about 4 dry wt %.

The amount of polyvinyl alcohol (e.g., an amount ranging from greater than 2 dry wt % to about 7 dry wt %) included in the coating composition improves the mechability performance of the packaging liner including the coating composition (as compared to the mechability performance of a liner including a coating composition that does not include polyvinyl alcohol or that includes polyvinyl alcohol in a lower amount). In some examples, the amount of polyvinyl alcohol included in the coating composition may improve the mechability performance of the packaging liner that is printed with high ink coverage (e.g., 5 or 6 ink drops per pixel) at high printing speeds (e.g., a printing speed ranging from about 400 feet per minute (fpm) up to 600 fpm).

Examples of polyvinyl alcohol are commercially available under the tradenames MOWIOL® 4-98 and MOWIOL®6-98, from Kuraray America, Inc. (Houston, Tex.).

The coating composition also includes the fixing agent, which is selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof. Some examples of the cation include sodium, calcium, copper, nickel, magnesium, zinc, barium, iron, aluminum, and chromium, and combinations thereof. In an example, the fixing agent is the water-soluble multi-valent metallic salt. In these examples, the fixing agent may include (i) a cation of a metal selected from the group consisting of Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof. In any of the examples disclosed herein, the fixing agent is a non-polymeric salt.

Some specific examples of the fixing agent include calcium chloride, magnesium chloride, calcium bromide, magnesium bromide, calcium nitrate, magnesium nitrate, aluminum chlorohydrate, and combinations thereof. In an example, the fixing agent is calcium chloride (CaCl₂).

In some examples, the fixing agent may have a solubility in water greater than or equal to 15 grams per 100 mL of water at 20° C. and 1 atm pressure. In some other examples, the fixing agent may have a solubility in water greater than or equal to 50 grams per 100 mL of water at 20° C. and 1 atm pressure.

A reaction may take place between the fixing agent and an anionic pigment in a liquid ink (applied to the coated liner) to fix the anionic pigment. The fixing agent fixes a printed image in/on the coated liner, where the coating composition is applied on the liner during the manufacture of the liner, and thus prior to the application of the liquid ink. As such, image quality (e.g., bleed, coalescence, text quality, etc.) is controlled.

The amount of the fixing agent in the coating composition may depend, in part, on the anionic activity of the liquid ink (due to the anionic pigment of the liquid ink), and/or the cationic activity of the fixing agent (due to the cation of the fixing agent). The amount of the fixing agent may be selected in order to immobilize the pigment in the liquid ink. In an example, the fixing agent may be present in the coating composition in an amount ranging from about 1 dry wt % to about 21 dry wt %. In other examples, the fixing agent may be present in the coating composition in an amount ranging from about 5 dry wt % to about 10 dry wt %, or from about 3 dry wt % to about 8.5 dry wt %. In yet another example, the fixing agent may be present in the coating composition in an amount ranging from about 4 dry wt % to about 6 dry wt %. In still another example, the fixing agent may be present in the coating composition in an amount of about 4 dry wt %. In yet another example, the fixing agent may be present in the coating composition in an amount of about 5 dry wt %. In yet another example, the fixing agent may be present in the coating composition in an amount of about 6 dry wt %.

The amount of the fixing agent in the coating composition may also depend, in part, on the amount of the polyvinyl alcohol in the coating composition. In an example of the coating composition, a ratio of the fixing agent to the polyvinyl alcohol ranges from about 1:2 to about 10:3. In yet another example of the coating composition, the ratio of the fixing agent to the polyvinyl alcohol ranges from about 4:3 to about 5:4.

Examples of the coating composition disclosed herein also include an inorganic pigment. The type and/or amount of the inorganic pigment of the coating composition may be selected to obtain desirable media penetration for the ink ingredients. In some examples, a mixture of inorganic pigments may be used to control the penetration rate.

In an example, the inorganic pigment is selected from the group consisting of calcined clay, modified calcium carbonate (MCC), ground calcium carbonate (GCC), and combinations thereof. The ground calcium carbonate (GCC) may be fine and/or ultra-fine.

An example of calcined clay is commercially available as KAOCAL® from Thiele Kaolin Company (Sandersville, Ga.) and has a particle size distribution of about 83-92% particles finer than 2 μm. Some examples of ground calcium carbonate include HYDROCARB® 60 (a fine ground calcium carbonate having a solids content of about 74% and a median diameter of about 1.4 μm) and HYDROCARB® 90 (an ultrafine ground calcium carbonate having a solids content of about 76% and a median diameter of about 0.7 μm), both available from Omya North America (Cincinnati, Ohio).

In some examples, the inorganic pigment is calcined clay; or a mixture of calcined clay and fine ground calcium carbonate; or a mixture of calcined clay and ultrafine ground calcium carbonate; or a mixture of calcined clay and fine ground and ultrafine ground calcium carbonate. As one example, the mixture contains, by dry weight, at least about 50% of fine and/or ultrafine ground calcium carbonate. In some other examples, the inorganic pigment of the coating composition is an ultrafine ground calcium carbonate (having a median particle size of about 0.7 μm), calcined clay (having a particle size distribution of about 83-92% of particles finer than 2 μm), and/or a combination thereof.

The particle size of the inorganic pigment may affect the gloss levels of the resulting printed image. A smaller particle size of the inorganic pigment may result in a higher gloss level in the resulting print. As used herein, the term “particle size”, refers to the diameter of a substantially spherical particle (i.e., a spherical or near-spherical particle having a sphericity of >0.84), or the average diameter of a non-spherical particle (i.e., the average of multiple diameters across the particle). The inorganic pigment may have a median particle size ranging from about 0.5 μm to about 5 μm. In another example, the inorganic pigment has a median particle size ranging from about 0.5 μm to about 2 μm. In still other examples, the inorganic pigment has a median particle size ranging from about 0.75 μm to about 2 μm, or has a median particle size ranging from about 0.5 μm to about 1 μm.

In an example, the inorganic pigment may be present in the coating composition in an amount ranging from about 75 dry wt % to about 85 dry wt %. In another example, the inorganic pigment may be present in the coating composition in an amount of about 75 dry wt %. In another example, the inorganic pigment may be present in the coating composition in an amount of about 85 dry wt %.

Examples of the coating composition also include a latex. As used herein, the term “latex” refers to a polymer that is capable of being dispersed in an aqueous medium. The latex may act as a binder in the coating composition. In an example, the latex is present in the coating composition in an amount ranging from about 5.5 dry wt % to about 8.5 dry wt %. In another example, the latex is present in the coating composition in an amount of about 8.5 dry wt %. In still another example, the latex is present in the coating composition in an amount of about 6 dry wt %.

In an example, the latex is formed from a monomer selected from the group consisting of vinyl monomers, allylic monomers, olefin monomers, unsaturated hydrocarbon monomers, and combinations thereof.

Classes of vinyl monomers include vinyl aromatic monomers (e.g., styrene), vinyl aliphatic monomers (e.g., butadiene), vinyl alcohols, vinyl halides, vinyl esters of carboxylic acids (e.g., vinyl acetate), vinyl ethers, (meth)acrylic acid, (meth)acrylates, (meth)acrylamides, (meth)acrylonitriles, and mixtures of two or more of the above, for example. The term “(meth) acrylic latex” includes polymers of acrylic monomers, polymers of methacrylic monomers, and copolymers of the aforementioned monomers with other monomers.

Examples of vinyl aromatic monomers that may be used to form the latex include styrene, 3-methylstyrene, 4-methylstyrene, styrene-butadiene, p-chloro-methylstyrene, 2-chlorostyrene, 3-chlorostyrene, 4-chlorostyrene, divinyl benzene, vinyl naphthalene and divinyl naphthalene. Vinyl halides that may be used include, for example, vinyl chloride and vinylidene fluoride. Vinyl esters of carboxylic acids that may be used include, for example, vinyl acetate, vinyl butyrate, vinyl methacrylate, vinyl 3,4-dimethoxybenzoate, vinyl maleate and vinyl benzoate. Examples of vinyl ethers that may be employed include butyl vinyl ether and propyl vinyl ether.

In some examples, the latex may be a styrene/butadiene latex copolymer (SBR type latex). In some other examples, the latex may be a styrene/butadiene/acrylonitrile latex copolymer (ABS type latex). Some examples of the latex polymer/copolymer include aqueous, anionic carboxylated styrene/butadiene copolymer dispersions commercially available under the tradenames LITEX® PX 9710, LITEX® 9720, LITEX® 9730 and LITEX® PX 9740, from Synthomer (Essex, UK), styrene/butadiene/acrylonitrile copolymers commercially available under the tradenames GENCRYL® 9525, GENCRYL® 9750, and GENCRYL® 9780, from Omnova, a styrene/butadiene copolymer commercially available under the tradename STR 5401, from Dow Chemical Company (Midland, Mich.), and/or combination(s) thereof.

The latex may be a colloidal dispersion of polymer particles in a solvent. The polymer particles of the latex may have several different morphologies. For example, the polymer particles may be individual spherical particles containing polymer compositions of high T_{g} hydrophilic (hard) component(s) and/or low T_{g} hydrophobic (soft) component(s) that may be interdispersed according to IPN (interpenetrating networks), although it is contemplated that the high T_{g} hydrophilic and T_{g} hydrophobic components may be interdispersed in other ways. For another example, the polymer particles may be made of a low T_{g} hydrophobic core surrounded by a continuous or discontinuous high T_{g} hydrophilic shell. For another example, the polymer particle morphology may resemble a raspberry, in which a low T_{g} hydrophobic core is surrounded by several smaller high T_{g} hydrophilic particles that are attached to the core. For still another example, the polymer particles may include 2, 3, or 4 particles that are at least partially attached to one another.

The high T_{g} hydrophilic component(s)/shell/particles and low T_{g} hydrophilic component(s)/core/particles may be defined in relation to each other (i.e., the high T_{g} hydrophilic component(s)/shell/particles have a T_{g} higher than the low T_{g} hydrophilic component(s)/core/particles, and the low T_{g} hydrophilic component(s)/core/particles have a T_{g} lower than the high T_{g} hydrophilic component(s)/shell/particles). In some examples, the high T_{g} hydrophilic component(s)/shell/particles have a T_{g} higher than 25° C. In other examples, the high T_{g} hydrophilic component(s)/shell/particles have a T_{g} higher than 45° C. In some examples, the low T_{g} hydrophilic component(s)/core/particles have a T_{g} lower than 25° C. In other examples, the low T_{g} hydrophilic component(s)/core/particles have a T_{g} lower than 5° C.

In some examples disclosed herein, the polymer particles of the latex are heteropolymers or co-polymers. The heteropolymers may include a more hydrophobic component and a more hydrophilic component. In these examples, the hydrophilic component renders the particles dispersible in the coating composition, while the hydrophobic component is capable of coalescing upon the drying of the coating composition to form an ink-receiving layer.

Examples of low T_{g} monomers that may be used to form the hydrophobic component include C4 to C8 alkyl acrylates or methacrylates, styrene, substituted methyl styrenes, polyol acrylates or methacrylates, vinyl monomers, vinyl esters, or the like. Some specific examples include methyl methacrylate, butyl acrylate, butyl methacrylate, hexyl acrylate, hexyl methacrylate, ethyl acrylate, ethyl methacrylate, propyl acrylate, propyl methacrylate, 2-ethylhexyl acrylate, 2-ethylhexy methacrylate, hydroxyethyl acrylate, lauryl acrylate, lauryl methacrylate, octadecyl acrylate, octadecyl methacrylate, isobornyl acrylate, isobornyl methacrylate, stearyl methacrylate, ethylene glycol dimethacrylate, diethylene glycol dimethacrylate, triethylene glycol dimethacrylate, tetrahydrofurfuryl acrylate, alkoxylated tetrahydrofurfuryl acrylate, 2-phenoxyethyl methacrylate, benzyl acrylate, ethoxylated nonyl phenol methacrylate, cyclohexyl methacrylate, trimethyl cyclohexyl methacrylate, t-butyl methacrylate, n-octyl methacrylate, tridecyl methacrylate, isodecyl acrylate, dimethyl maleate, dioctyl maleate, acetoacetoxyethyl methacrylate, diacetone acrylamide, pentaerythritol tri-acrylate, pentaerythritol tetra-acrylate, pentaerythritol tri-methacrylate, pentaerythritol tetra-methacrylate, divinylbenzene, styrene, methylstyrenes (e.g., α-methyl styrene, p-methyl styrene), vinyl chloride, vinylidene chloride, vinylbenzyl chloride, acrylonitrile, methacrylonitrile, N-vinyl imidazole, N-vinylcarbazole, N-vinyl-caprolactam, combinations thereof, derivatives thereof, or mixtures thereof.

The heteropolymer may be formed of at least two of the previously listed monomers, or at least one of the previously listed monomers and a high T_{g} hydrophilic monomer, such as an acidic monomer. Examples of acidic monomers that can be polymerized in forming the latex polymer particles include acrylic acid, methacrylic acid, ethacrylic acid, dimethylacrylic acid, maleic anhydride, maleic acid, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2 acrylamido-2-methyl-1-propanesulfonic acid, combinations thereof, derivatives thereof, or mixtures thereof. Other examples of high T_{g} hydrophilic monomers include acrylamide, methacrylamide, monohydroxylated monomers, monoethoxylated monomers, polyhydroxylated monomers, or polyethoxylated monomers.

In the heteropolymers disclosed herein, the low T_{g} hydrophobic component(s) make up from about 65% to about 100% of the polymer, and the high T_{g} hydrophilic component(s) make up from about 0.1% to about 35% of the polymer.

In an example, the selected monomer(s) is/are polymerized to form the desirable heteropolymer. Any suitable polymerization process may be used. For example, hydrophobic-hydrophilic polymer particles can be formed by any of a number of techniques, such as: i) attaching a high T_{g} hydrophilic polymer onto the surface of a low T_{g} hydrophobic polymer, ii) copolymerizing low T_{g} hydrophobic and high T_{g} hydrophilic monomers using ratios that lead to a more high T_{g} hydrophilic outer component or shell, iii) adding high T_{g} hydrophilic monomer (or excess high T_{g} hydrophilic monomer) toward the end of the copolymerization process so there is a higher concentration of high T_{g} hydrophilic monomer copolymerized at or near the surface, or iv) any other method known in the art to generate a higher T_{g} hydrophilic outer component or shell relative to the inner component or core. These hydrophobic-hydrophilic polymer particles may be core-shell particles. It is to be understood, however, that these techniques may also form latex polymer particles with other morphologies, as noted herein.

In some examples, the coating composition further includes a surfactant/dispersant. The surfactant/dispersant may contribute to the stabilization of component(s) in the coating composition. In an example, the surfactant/dispersant may be present in the coating composition in an amount ranging from greater than 0 dry wt % to about 2 dry wt %. In another example, the surfactant/dispersant may be present in the coating composition in an amount ranging from greater than 0.075 dry wt % to about 0.25 dry wt %. In still another example, the surfactant/dispersant may be present in the coating composition in an amount of about 0.25 dry wt %. An example of a suitable surfactant/dispersant is DISPEX® AA 4140 NS (a solution of a sodium salt of an acrylic polymer in water, previously sold as DISPEX® N40 V, and available from BASF Corp.).

In some examples, the coating composition further includes a wax. The wax may serve to provide scratch resistance and friction reduction. In other words, the wax may improve the scratch/rub resistance of the printed liner (having the coating composition and a liquid ink applied thereon). In an example, the wax may provide print scratch resistance prior to the application of an over-print varnish (OPV) (e.g., when exposed to media roller(s) and drying). In another example, the wax may serve as a rheology stabilizer. In still another example, the wax may carry a dispersant/surfactant that may stabilize the coating composition.

In some examples, the wax has a median particle size ranging from about 1 μm to about 10 μm. In another example, the median particle size of the wax ranges from about 5 μm to about 10 μm. As used herein, the term “median particle size”, refers to the D50 or the median diameter of the particle size distribution, where 50% of the population is above the D50 value and 50% is below the D50 value.

The wax that is utilized may depend, in part, upon the temperature of the corrugation process, the melting point of the wax, and formulation of the coating composition. For example, the wax may be selected so that it is compatible with the fixing agent (i.e., the wax is able to remain stable in the coating composition, which also includes the fixing agent). When the wax is not compatible with the fixing agent, the wax may become destabilized (i.e., may crash out of the coating composition) in the presence of the fixing agent, which may result in flocculation.

Suitable examples of the wax include polypropylene wax, polyethylene wax, polytetrafluoroethylene wax, and the like. The polyethylene wax may be a high density wax or a low density wax. An example of a suitable high density polyethylene (HDPE) wax is ULTRALUBE® D806 available from Keim-additec Surface GmbH (Kirchberg, Germany). ULTRALUBE® D806 is a water-based, white dispersion with an average particle size of the wax of about 7 μm and a melting point of the wax of about 128° C.

In an example, the wax may be present in the coating composition in an amount ranging from greater than 0 dry wt % to about 8.5 dry wt %. In another example, the wax may be present in the coating composition in an amount of about 1.5 dry wt %. In still another example, the wax may be present in the coating composition in an amount of about 2 dry wt %.

In some examples, the coating composition further includes a plastic pigment. The plastic pigment, if included, may serve to enhance paper gloss. In an example, the plastic pigment may be present in the coating composition in an amount ranging from greater than 0 dry wt % to about 8.5 dry wt %. In an example, the plastic pigment may be present in the coating composition at about 4.5 dry wt %. In still an example, the plastic pigment may be present in the coating composition at about 5 dry wt %.

Examples of the plastic pigment may include styrene based pigments and/or hollow sphere type polystyrene based pigments. In some examples, the plastic pigment has a glass transition temperature (T_{g}) equal to or greater than 85° C. In some other examples, the plastic pigment has a T_{g} equal to or greater than 100° C. One example of the plastic pigment includes ROPAQUE™ AF1055 from Dow Chemical. ROPAQUE™ AF1055 is a hollow sphere styrene acrylic polymeric pigment with a 1.0 μm particle size and a 55% void volume. Another example of the plastic pigment is LYTRON™ HG80 from Omnova Solutions Inc. LYTRON™ HG80 is a hollow sphere pigment with a 1 μm unimodal particle size distribution.

In some examples, the coating composition may also include an additive. The additive may be a rheology modifier, a dye, a plastic pigment, an optical brightening agent, a dispersing agent, a crosslinker, or a combination thereof. In an example, the total amount of additive(s) present in the coating composition ranges from greater than 0 dry wt % to about 20 dry wt %.

In some examples of the coating composition, the inorganic pigment is present in an amount ranging from about 75 dry wt % to about 85 dry wt %; the latex is present in an amount ranging from about 5.5 dry wt % to about 8.5 dry wt %; and the fixing agent is present in an amount ranging from about 1 dry wt % to about 21 dry wt %.

In some other examples, the coating composition further comprises: the surfactant/dispersant, the wax, the plastic pigment, or combinations thereof, and wherein when included: the surfactant/dispersant is present in an amount ranging from greater than 0 dry wt % to about 2 dry wt %; the wax is present in an amount ranging from greater than 0 dry wt % to about 8.5 dry wt %; and the plastic pigment is present in an amount ranging from greater than 0 dry wt % to about 8.5 dry wt %.

The coating composition may also include water. In an example, deionized water may be used. Water may be present in an amount sufficient to achieve the desired total solids content of the coating composition. In an example, the coating composition has a solids content ranging from about 50 wt % to about 70 wt %, based on the total weight of the coating composition. In another example, the coating composition has a solids content ranging from about 50 wt % to about 65 wt %, based on the total weight of the coating composition.

In some examples, the coating composition may be formed by mixing from about 95 dry parts to about 105 dry parts of the inorganic pigment with the other dry components of the coating composition, and then adding water to achieve the desired solids content. In some other examples, the coating composition may be formed by mixing about 100 dry parts of the inorganic pigment with the other dry components of the coating composition, and then adding water to achieve the desired solids content. In any of these examples, the total dry parts may range from about 120 dry parts to about 130 dry parts.

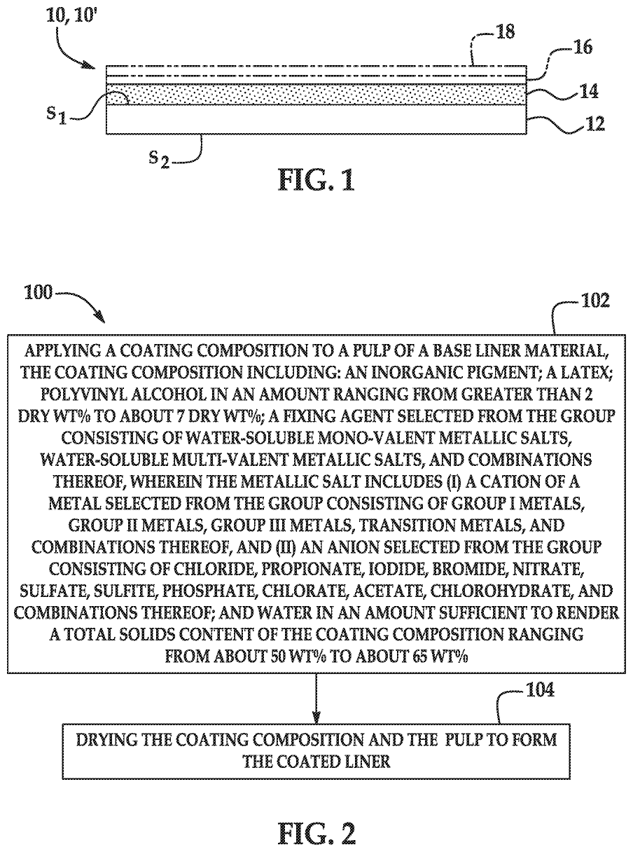

The coating composition may be used to form an ink-receiving layer of a coated liner for corrugated packaging. An example of the coated liner 10 is shown in FIG. 1.

In an example, the coated liner 10 for corrugated packaging comprises: a base liner 12; and an ink-receiving layer 14 disposed on the base liner 12, the ink-receiving layer 14 including: an inorganic pigment; a latex; polyvinyl alcohol in an amount ranging from greater than 2 wt % to about 7 wt %, based on a total weight of the ink-receiving layer 14; and a fixing agent selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof.

In an example, the coated liner 10 consists of the base liner 12 and the ink-receiving layer 14, with no other layers. In other examples, the coated liner 10 may include additional layer(s) (e.g., a curl control layer on a back side S₂ of the base liner 12, i.e., on a surface opposed to the surface having the ink-receiving layer 14 thereon).

A printed liner 10′ includes an ink layer 16 (shown in phantom in FIG. 1) fixed on and/or in the ink-receiving layer 14 of the coated liner 10. An over-print varnish layer 18 may also be included (if desired) on the ink layer 16 on the printed liner 10′.

The base liner 12 of the coated liner 10 acts as a support layer. The base liner 12 provides structural integrity for the resultant coated liner 10. In some examples, the base liner 12 serves as the bottom of the coated liner 10. In other examples, the back side S₂ of the base liner 12 may coated with a layer (e.g., a curl control layer or another ink-receiving layer 14). The material of the base liner 12 should have good affinity and good compatibility for the liquid ink that is to be applied to the coated liner 10. As such, the base liner 12 should have the ability to absorb the ink vehicle of the liquid ink (i.e., move the water and/or co-solvent of the ink vehicle away from the ink-receiving layer 14). Moreover, the base liner 12 contains a material that serves as a base upon which the coating composition can be applied to form the ink-receiving layer 14.

The base liner 12 can be either bleached or non-bleached. In some examples, the base liner 12 is a bleached liner. The base liner 12 may be bleached throughout. Any suitable bleached fibers for making liner paper may be used for the base liner 12. Suitable fibers include, for example, bleached eucalyptus kraft fibers or bleached recycled fibers (often referred to as Testliner). Other examples of the base liner 12 include brown kraft liners or white top liners. As an example, the base liner 12 may be a brown kraft liner made from kraft pulp from pines or other conifers. As another example, the base liner 12 may be a white top liner including two ply sheets where the top ply is made of bleached fiber (e.g., bleached eucalyptus kraft fibers), and the bottom ply is made of unbleached fiber (e.g., a mixture of pine and eucalyptus kraft fibers). Suitable fibers include hardwood fibers, softwood fibers, recycled fibers, and combinations thereof. In an example, the base liner 12 is made of one single ply of bleached fibers. In another example, the base liner 12 is made of multiple ply sheets of bleached fibers.

In some examples, the base liner 12 has a basis weight of about 90 grams per square meter (g/m² or gsm) to about 400 gsm, or about 130 gsm to about 250 gsm.

In an example, the base liner 12 may have a thickness along substantially the entire length ranging from about 0.025 mm to about 0.5 mm.

In an example, the coating composition is coated on the base liner 12 during the manufacturing of the base liner 12 to initiate the formation of the ink-receiving layer 14. In an example, the coating composition may be applied or coated on a pulp of the base liner material when the pulp includes at least 90% solids and less than 100% solids (by weight). Examples of suitable coating techniques include slot die coating, roller coating, fountain curtain coating, blade coating, rod coating, air knife coating, spray coating, coating with a size press, gravure applications, and air brush applications.

After being coated, the coating composition on the pulp of the base liner material may be dried to at least substantially remove liquid from the pulp to form the base liner 12 and from the coating composition to form the ink-receiving layer 14. In an example, the coating composition may be dried until the coated liner 10 has a predetermined moisture content. For example, the coating composition may be dried until the coated liner 10 has a moisture content ranging from about 1 wt % to about 8 wt %, or until the coated liner 10 has a moisture content ranging from about 3 wt % to about 7 wt % (based on the total weight of the coated liner 10).

As shown in FIG. 1, the ink-receiving layer 14 of the coated liner 10 is formed on one side S₁ of the base liner 12 (e.g., directly on top of the base liner 12). It is to be understood that, as used herein, the terms “formed on”, “disposed on”, “deposited on”, “established on”, and the like are broadly defined to encompass a variety of divergent layering arrangements and assembly techniques. These arrangements and techniques include i) the direct attachment of a layer (e.g., the ink-receiving layer 14) to another layer (e.g., the base liner 12) with no intervening layers therebetween and ii) the attachment of a layer (e.g., the ink-receiving layer 14) to another layer (e.g., base liner 12) with one or more layers therebetween, provided that the one layer being “formed on”, “disposed on”, “deposited on”, or “established on” the other layer is somehow supported by the other layer (notwithstanding the presence of one or more additional material layers therebetween). An example with multiple layers is when the base liner 12 includes multiple plies. Further, the phrases “formed directly on”, “disposed directly on”, “deposited directly on”, “established directly on” and/or the like are broadly defined herein to encompass a situation(s) wherein a given layer (e.g., ink-receiving layer 14) is secured to another layer (e.g., base liner 12) without any intervening layers therebetween. Any statement used herein which indicates that one layer is on another layer is to be understood as involving a situation wherein the particular layer that is “on” the other layer in question is the outermost of the two layers relative to incoming ink materials being delivered by the printing system of interest. It is to be understood that the characterizations recited above are to be effective regardless of the orientation of the coated liner materials under consideration.

In an example of the coated liner 10, the ink-receiving layer 14 is disposed on top of the base liner 12. In another example of the coated liner 10, the ink-receiving layer 14 is disposed directly on top of the base liner 12.

The ink-receiving layer 14 is formed from the coating composition. As such, the components of the coating composition (except for water, which is at least substantially removed during drying (e.g., the moisture content of the coated liner 10 may range from about 1 wt % to about 8 wt %, or from about 3 wt % to about 7 wt %, based on the total weight of the coated liner 10)) are present in the ink-receiving layer 14 in amounts (in wt %) about equal to, or equal to the amounts (in dry wt %) in the coating composition. In an example, the inorganic pigment is present in an amount ranging from about 75 wt % to about 85 wt %, based on the total weight of the ink-receiving layer 14; the latex is present in an amount ranging from about 5.5 wt % to about 8.5 wt %, based on the total weight of the ink-receiving layer 14; and the fixing agent is present in an amount ranging from about 1 wt % to about 21 wt %, based on the total weight of the ink-receiving layer.

The ink-receiving layer 14 may provide a good absorption rate of water, solvent and/or ink vehicle. In an example, the absorption rate is fast enough that the pigment in the ink composition applied to the coated liner 10 interacts with the fixing agent in the ink-receiving layer 14 fast enough that image quality issues, such as bleed and/or coalescence issues are avoided at high printing speeds (e.g., a high printing speed of at least 400 feet per minute (fpm)). The ink-receiving layer 14 may also provide good durability by protecting and minimizing damage to the printed image (printed liner 10′). The ink-receiving layer 14 may also enhance sheet gloss.

The coat weight of the ink-receiving layer may depend, in part, on the paper machine configuration and the desired visual coating appearance. In an example, the ink-receiving layer 14 may have a coat weight ranging from about 5 grams per square meter (gsm) to about 30 gsm. In another example, the ink-receiving layer 14 may have a coat weight ranging from about 10 gsm to about 20 gsm.

After drying, the coated liner 10 may further be calendered (either in-line calendered (hard or soft nip), or offline supercalendered) at a suitable speed, temperature, pressure and number of nips to reach a desired thickness (caliper), a desired smoothness, and/or a desired gloss level.

As shown in FIG. 1, in some examples, the coated liner 10 has no layer applied to the other/back side S₂ of the base liner 12 (i.e., the side S₂ of the base liner 12 opposed to the one side S₁). In other examples (not shown), the ink-receiving layer 14 is applied to both sides S₁, S₂ of the base liner 12.

In still other examples (not shown) a curl control layer (not shown) may be applied to the side S₂ of the base liner 12 opposed to the one side S₁ having the ink-receiving layer 14 thereon. The curl control layer may be used to balance the curl of the final product or to improve sheet feeding through printing, hot corrugation, and overcoat processes. In an example, the curl control layer includes starch.

Once the coated liner 10 is produced, the coated liner 10 may be wound into a roll. Then the roll of the coated liner 10 may be printed on in an inkjet type printer (e.g., an HP T400S webpress or an HP T1100S webpress) to form the printed liner 10′. The printed liner 10′ may be rewound until it is desirable to be integrated into a packaging material.

As shown in FIG. 1, the coated liner 10 may have an ink layer 16 disposed on the ink-receiving layer 14. The ink layer 16 may be formed by printing a liquid ink on the ink-receiving layer 14. While FIG. 1 shows the ink layer 16 on the ink-receiving layer 14, the liquid ink may be at least partially absorbed by the ink-receiving layer 14 and/or the base liner 12. Thus, the ink layer 16 may be at least partially within the ink-receiving layer 14 and/or the base liner 12. Further, while the ink layer 16 is shown as covering all of the ink-receiving layer 14, the liquid ink may be selectively printed on less than all of the ink-receiving layer 14, and thus, the ink layer 16 may cover less than all of the ink-receiving layer 14.

The liquid ink may include a liquid vehicle and a colorant. The ink may be any color, such as black, cyan, magenta, yellow, etc. In some examples, the ink compositions are inkjet compositions, and as such, the ink compositions are well adapted to be used in an inkjet device and/or in an inkjet printing process. The liquid ink may be printed on the coated liner 10 by any suitable inkjet printing technique, such as thermal, acoustic, continuous or piezoelectric inkjet printing.

In some examples, the liquid ink is an aqueous inkjet ink composition, and as such, the ink composition includes a water-based liquid vehicle and a colorant. In other examples, the liquid ink is a solvent-based inkjet ink composition, and as such, the ink composition includes a solvent-based aqueous liquid vehicle and a colorant. In some examples, the colorant is selected from a black colorant, a cyan colorant, a magenta colorant, and a yellow colorant. The colorant in the liquid ink may be an anionically dispersed colorant that can react with the fixing agent in the ink-receiving layer 14. The ink vehicle may include water or a main solvent and at least one co-solvent present in an amount ranging from about 1 wt % to about 25 wt % (based on the total weight of the liquid ink). The liquid ink may also contain at least one surfactant/dispersant present in an amount ranging from about 0.1 wt % to about 8 wt % and at least one polymer present in an amount ranging from about 0 wt % to about 6 wt % by total weight of the ink composition. The liquid ink may further include other components common to inkjet inks, such as antimicrobial agents (e.g., biocides and fungicides), anti-kogation agents (for thermal inkjet printing), etc.

In some other examples, the liquid ink may be chosen from a pigment-based inkjet ink, a pigmented latex-based inkjet ink, a UV curable inkjet ink, or a dye-based inkjet ink.

As shown in FIG. 1, an over-print varnish layer 18 may be disposed on the ink layer 16. The over-print varnish layer 18 may protect the ink layer 16, and thus, improve the durability of the printed image (printed liner 10′). The over-print varnish layer 18 may also improve the gloss of the printed liner 10′.

The over-print varnish layer 18 may be formed on the ink layer 16 by applying an over-print varnish. Examples of the over-print varnish include INXKOTE® AC911 and INXKOTE® AC9116 from INX International, AQUAFLEX® H.R. from Flint Group, and THERMAGLOSS® 1394E, THERMAGLOSS® 426, THERMAGLOSS® 425, THERMAGLOSS® 475, THERMAGLOSS® 460, and DIGIGUARD® gloss 100 from Michelman.

After forming the ink layer 16 and the over-print varnish layer 18 (when desired), the printed liner 10′ may be used to form corrugated paper board. Corrugated paper board is a material that includes a fluted medium or a corrugated medium (also referred to herein as a fluted corrugated sheet) and one or two flat printable package liners, also known as linerboards, (as outer layer(s)). In an example, the fluted medium is a middle layer, sandwiched between two printable package liners. In the examples disclosed herein, the coated liner(s) 10 may be used as the printable package liner(s). The fluted medium may be made of kraft containerboard, a paper board material that is usually over 0.01 inches (0.25 mm) thick.

Corrugated paper board is made on flute lamination machines or corrugators and is used in the manufacture of, for example, shipping containers and corrugated boxes. The exposed surface(s) of the coated liner(s) 10 may be printed on (i.e., has a graphic, text, or the like printed thereon). As such, the ink layer 16 and the over-print varnish layer 18 (when desired) may be disposed on the coated liner 10 to form the printed liner 10′. Then the printed liner(s) 10′ may be assembled with the fluted medium in the corrugator. While the following description relates to the printer liner(s) 10′, it is to be understood that the liner 10 may also be used in the corrugation process.

The printed liner 10′ may be put on the corrugator and joined with a backing layer. The backing layer includes the fluted medium and may also include another liner, which may be a printed liner 10′ or a non-printed liner 10. In an example, the corrugator starts with three liner streams. One of the streams may be turned into the fluted medium (e.g., with a corrugating roll) and glued to a liner (the second liner stream, which may be a backside liner and may or may not be a printed liner 10′). Then, the printed liner 10′ (the third liner stream) may be glued to the other side of the fluted medium. Then, the fluted medium with the two liners attached thereto may be pressed (e.g., with pressure rolls) against a heated plate to form the corrugated paper board. The corrugation process subjects the components, including the printed liner 10′, to elevated temperatures, on the order of about 350° F. (about 177° C.).

In an example, the liner(s) (e.g., the printed liner 10′) may be exposed to a preheater and/or a pressure roll prior to being attached (e.g., glued) to the fluted medium. The liner(s) 10′ may be exposed to the preheater and/or the pressure roll to prepare the liner(s) 10′ to be attached to the fluted medium. The preheater and/or the pressure roll may help the gelatization of an adhesive (e.g., glue/starch) used and/or may balance out the moisture content of the liner(s) 10′.

In another example, prior to being turned into the fluted medium, the respective liner may be exposed to a pre-conditioner. The pre-conditioner may prepare the respective liner to be corrugated and/or to be attached (e.g., glued) to the exterior (or interior) liners.

After the corrugated paper board is formed, the corrugated paper board may go through a cooling section and/or a triplex, slitting, and scoring section.

Corrugated boxes may include the corrugated paper board, and may be used as shipping containers. These containers may require printing and labels to identify the contents, to provide legal and regulatory information, and to provide bar codes for routing. Boxes that are used for marketing, merchandising and point-of-sale often have high graphics to help communicate the contents. The coated liner 10 disclosed herein provides the boxes with a printable surface, and the coated liner 10′ disclosed herein provides the boxes with a printed on surface.

Also disclosed herein is a method 100 for producing a coated liner 10 for corrugated packaging. An example of the method 100 is shown in FIG. 2.

The method 100 for producing a coated liner 10 for corrugated packaging comprises: applying a coating composition to a pulp of a base liner material, the coating composition including: an inorganic pigment; a latex; polyvinyl alcohol in an amount ranging from greater than 2 dry wt % to about 7 dry wt %; and a fixing agent selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof; and water in an amount sufficient to render a total solids content of the coating composition ranging from about 50 wt % to about 65 wt % (as shown at reference numeral 102); and drying the coating composition and the pulp to form the coated liner 10 (as shown at reference numeral 104). The ink-receiving layer 14 is formed of the dried coating composition and the base liner 12 is formed of the dried base liner material.

The coating composition, the coated liner 10, and their components may be as described above. In an example of the method 100, the pulp of the base liner material includes from about 90% solids to less than 100% solids (based on a total weight of the pulp).

In some examples of the method 100, the applying of the coating composition is accomplished at a coating speed up to about 3000 feet per minute (fpm).

In some examples of the method 100, the applying of the coating composition is accomplished with a size press, a rod coater, a roll coater, a blade coater, air knife coater, a slot die coater, a fountain curtain coater, a gravure coater, an air brush, or a spray coater.

In some examples, the applying of the coating composition may include applying the coating composition on one side S₁ of the base liner 12 to form the ink-receiving layer 14 on the one side S₁ of the base liner 12. In other examples, the applying of the coating composition may include applying the coating composition on both sides S₁, S₂ of the base liner 12 to form the ink-receiving layer 14 on both sides S₁, S₂ of the base liner 12.

In some examples of the method 100, the method 100 may further include applying a curl control layer composition to a side S₂ of the base liner 12 opposite to the side S₁ of the base liner 12 on which the ink-receiving layer 14 is or is to be formed. The application and drying of the curl control layer composition forms a curl control layer. The curl control layer may be formed (by applying the curl control layer composition) before or after the ink-receiving layer 14 is formed (by applying the coating composition). As mentioned above, the curl control layer composition may include starch.

As mentioned above, the method 100 includes drying the coating composition and the pulp of the base liner material. The method 100 may further include drying the curl control layer composition. In any of these examples, the drying of the coating composition and the pulp of the base liner material and/or the drying of the curl control layer composition may be accomplished in-line (i.e., on the same machine on which the coating composition and/or the curl control composition is applied). The amount of time for which the coating composition and the pulp of the base liner material and/or the curl control layer composition are dried may depend, in part, on the coating speed and the base liner material used.

In some examples of the method 100, a coat weight of the applied and dried coating composition ranges from about 5 grams per square meter (gsm) to about 30 grams per square meter (gsm). In other examples, the coat weight of the applied and dried coating composition ranges from about 10 grams per square meter (gsm) to about 20 grams per square meter (gsm).

In an example, the moisture content of the coated liner 10 after drying ranges from about 1 wt % to about 8 wt % (based on the total weight of the coated liner 10). In another example, the moisture content of the coated liner 10 after drying ranges from about 3 wt % to about 7 wt %.

In some examples of the method 100, the method 100 may further include calendering the ink-receiving layer 14. In these examples, the calendering may be accomplished by in-line calendering (hard or soft nip), or by offline supercalendering. The calendering may be accomplished at a suitable speed, temperature, pressure and number of nips to reach a desired smoothness and gloss level.

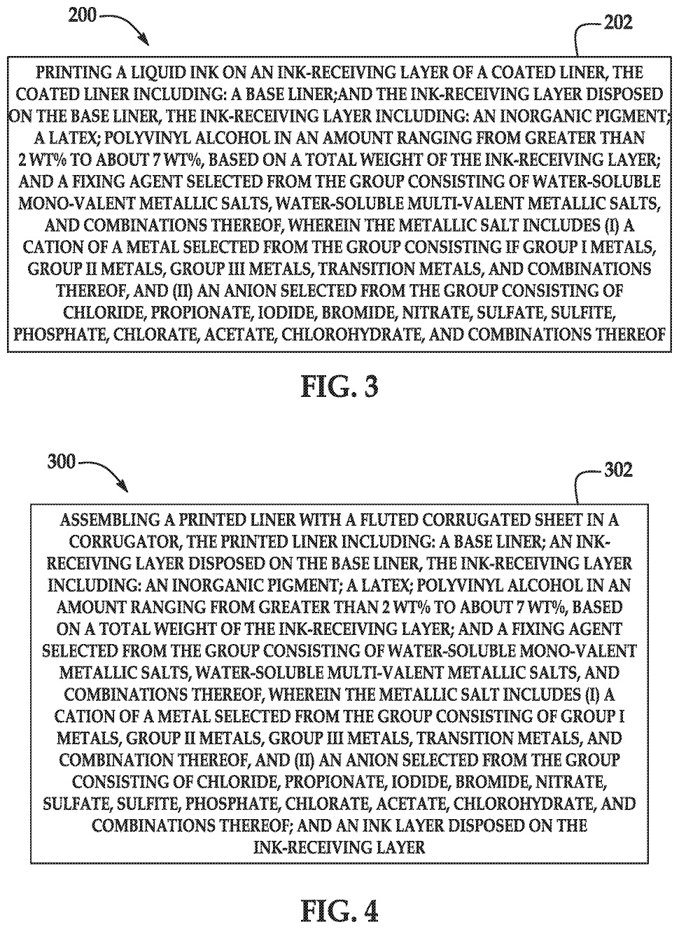

Also disclosed herein is a printing method 200 for producing a printed liner 10′. An example of the method 200 is shown in FIG. 3.

As shown at reference number 202, the method 200 comprises: printing a liquid ink on the ink-receiving layer 14 of the coated liner 10. The coated liner 10, the liquid ink, and their components may be as described above. In an example, the coated liner 10, to which the liquid ink is applied, includes: a base liner 12; and the ink-receiving layer 14 disposed on the base liner 12, the ink-receiving layer 14 including: an inorganic pigment; a latex; polyvinyl alcohol in an amount ranging from greater than 2 wt % to about 7 wt %, based on a total weight of the ink-receiving layer 14; and a fixing agent selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof.

The printing of the liquid ink may be accomplished at low print speeds or at high print speeds. The low printing speed is dependent upon the printer limits, and any low printing speed may be used. In some examples of the method 200, the printing of the liquid ink is accomplished at a printing speed up to 600 feet per minute (fpm).

In an example of the printing method 200, the liquid ink may be printed on the ink-receiving layer 14 of the coated liner 10 by any suitable printing process. Examples of printing processes include digital inkjet printing processes, such as thermal, acoustic, continuous or piezoelectric inkjet printing. Some examples of inkjet-based pre-print technologies include the HP T400S and T1100S webpresses.

In some examples of the method 200, the printing of the liquid ink includes printing 5 drops per pixel (dpp) or 6 drops per pixel (dpp). In some examples of the method 200, the printing of the liquid ink is at about 15 grams per square meter (gsm).

In some examples of the printing method 200, after printing the liquid ink on the ink-receiving layer 14, the method 200 may further include applying an over-print varnish onto the printed ink (i.e., the ink layer 16). The over-print varnish may be as described above.

In some examples, the liquid ink is printed in-line, then dried in-line prior to the in-line application of the over-print varnish. The drying of the over-print varnish may be accomplished by in-line drying the printed liner 10′. The amount of time which the printed ink is dried may depend on the print speed, the color density, color profile, and the base liner 12 used. In an example, the moisture content of the printed liner 10′ after drying ranges from about 1 wt % to about 8 wt % (based on the total weight of the printed liner 10′). In another example, the moisture content of the printed liner 10′ after drying ranges from about 2 wt % to about 5 wt %.

Also disclosed herein is a method 300 for producing a corrugated paper board. An example of the method 300 is shown in FIG. 4.

As shown at reference numeral 302, the method 300 comprises: assembling a printed liner 10′ with a fluted corrugated sheet in a corrugator, the printed liner 10′ including: a base liner 12; an ink-receiving layer 14 disposed on the base liner 12, the ink-receiving layer 14 including: an inorganic pigment; a latex; polyvinyl alcohol in an amount ranging from greater than 2 wt % to about 7 wt %, based on a total weight of the ink-receiving layer 14; and a fixing agent selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof; and an ink layer 16 disposed on the ink-receiving layer 14.

The printed liner 10′, the fluted corrugated sheet, and their components may be as described above.

In some examples of the method 300, a second printed liner 10′ may be assembled with the printed liner 10′ and the fluted corrugated sheet. In these examples, the printed liner 10′ may be assembled on one side of the fluted corrugated sheet and the second printed liner 10′ may be assembled on a side of the fluted corrugated sheet opposite to the side of the fluted corrugated sheet on which the printed liner 10′ is assembled. The second printed liner 10′ may be the same as or similar to the printed liner 10′.

In some other examples of the method 300, a non-printed liner may be assembled with the printed liner 10′ and the fluted corrugated sheet. In these examples, the printed liner 10′ may be assembled on one side of the fluted corrugated sheet and the non-printed liner may be assembled on a side of the fluted corrugated sheet opposite to the side of the fluted corrugated sheet on which the printed liner 10′ is assembled. The non-printed liner may be the same as or similar to the base liner 12 or the coated liner 10.

In some examples of the method 300, one fluted corrugated sheet may be used. In these examples, single layer paper board (i.e., a corrugated paper board with one fluted corrugated sheet) may be produced. The single layer paper board may be a single face board (i.e., a corrugated paper board with one printed liner 10′ attached to one side of the fluted corrugated sheet and no liner attached to the other side of the fluted corrugated sheet; or single wall board (i.e., a corrugated paper board with a liner (e.g., the printed liner 10′) attached to both sides of the fluted corrugated sheet).

In other examples of the method 300, multiple fluted corrugated sheets may be used. In these examples, double layer paper board (i.e., a corrugated paper board with two fluted corrugated sheets also known as double wall board), three layer paper board (i.e., a corrugated paper board with three fluted corrugated sheets also known as triple wall board), etc. may be produced. In these examples, an interior liner may separate the fluted corrugated sheets from each other. In other words, interior liners may be alternated with the fluted corrugated sheets so that each of the fluted corrugated sheets is attached to an interior liner or an exterior liner and no the fluted corrugated sheet is directly attached to another fluted corrugated sheet. The interior liner(s) may be the same as or similar to the base liner 12 or the coated liner 10.

In some examples, the assembling of the printed liner 10′ with the fluted corrugated sheet is accomplished in-line or offline with the printing of the liquid ink and/or the formation of the coated liner 10.

To further illustrate the present disclosure, an example is given herein. It is to be understood that this example is provided for illustrative purposes and is not to be construed as limiting the scope of the present disclosure.

### Example

Three examples of the coating composition (labeled E1, E2, and E3) and three comparative example coating compositions (labeled C1, C2, and C3) were prepared. The example coating compositions included 4 dry parts (about 3 dry wt %) of polyvinyl alcohol (example coating composition E2) or 5 dry parts (about 4 dry wt %) of polyvinyl alcohol (example coating compositions E1 and E3). The comparative example coating compositions included 1 dry part (less than 1 dry wt %) of polyvinyl alcohol (comparative coating composition C2), 1.25 dry parts (about 1 dry wt %) of polyvinyl alcohol (comparative coating composition C1), or 2.5 dry parts (about 2 dry wt %) of polyvinyl alcohol (comparative coating composition C3).

Each example coating composition corresponded to a comparative coating composition (i.e., E1 corresponded to C1, E2 corresponded to C2, and E3 corresponded to C3). The corresponding example and comparative coating compositions had the same formulations except for the amount of polyvinyl alcohol and/or the amount of latex.

The general formulations of the example and comparative coating compositions are shown in Table 1. Each number represents the dry parts of each component present in the example and comparative coating compositions.

TABLE 1

| | | E1 | C1 | E2 | C2 | E3 | C3 |
|---|---|---|---|---|---|---|---|
| | Specific | (dry | (dry | (dry | (dry | (dry | (dry |
| Ingredient | Component | parts) | parts) | parts) | parts) | parts) | parts) |
| Inorganic | HYDRO- | 80 | 80 | 80 | 80 | 80 | 80 |
| Pigment | CARB ® 90 | | | | | | |
| | (ultrafine | | | | | | |
| | ground calcium | | | | | | |
| | carbonate) | | | | | | |
| | KAOCAL ® | 20 | 20 | 20 | 20 | 20 | 20 |
| | (calcined clay) | | | | | | |
| Surfactant/ | DISPEX ® AA | 0.3 | 0.3 | 0.3 | 0.3 | 0.3 | 0.3 |
| Dispersant | 4140 NS | | | | | | |
| Latex | LITEX ® PX | 10 | 10 | 10 | 10 | 7.5 | 10 |
| | 9740 | | | | | | |
| Wax | ULTRA- | 0 | 0 | 2 | 2 | 2 | 2 |
| | LUBE ® D806 | | | | | | |
| Plastic | ROPAQUE ™ | 0 | 0 | 6 | 6 | 6 | 6 |
| Pigment | AF1055 | | | | | | |
| Fixing | Calcium | 5 | 5 | 5 | 5 | 2 | 2 |
| Agent | Chloride | | | | | | |
| Polyvinyl | MOWIOL ® | 5 | 1.25 | 4 | 1 | 5 | 2.5 |
| Alcohol | 4-98 | | | | | | |

Each of the example and comparative coating compositions was prepared with a mixer in a vessel. The dry parts were mixed with an amount of water sufficient to prepare the example and comparative coating compositions, such that each composition had a solids content ranging from about 54% solids to about 58% solids.

The example and comparative coating compositions were applied (using blade and/or rod coating) to bleached pulp and dried (using a heat gun and/or lab oven at a temperature of about 120° C. for about 30 minutes) to create example and comparative coated liners. The coat weight of one layer of the example and comparative coating compositions ranged from about 10 gsm to about 15 gsm.

An about 15 grams per square meter (gsm), violet pattern was printed on each of the example and comparative coated liners to create example and comparative printed liners. A web press test bed was used to print, and the printing speed was about 100 fpm (which correlates to from about 300 fpm to about 400 fpm on a web press). The violet pattern was a strip created with a combination of a magenta ink and a cyan ink. The example and comparative printed liners were dried for about 5 seconds under a 375° F. (˜191° C.) dryer of the web press test bed.

Then, each of the example and comparative printed liners were tested for mechability by rolling an aluminum roller at a temperature of about 100° C. back and forth across the print three times. The damage to each print was graded visually using a scale of 1-5, with 5 indicating no damage seen and 1 indicating severe damage to the ink layer with patches of complete ink removal and bare liner visible. The results of the mechability tests for each print are shown below in Table 2.

TABLE 2

| | Print on E1 | Print on C1 | Print on E2 | Print on C2 | Print on E3 | Print on C3 |
|---|---|---|---|---|---|---|
| | coated | coated | coated | coated | coated | coated |
| | liner | liner | liner | liner | liner | liner |
| Mechability | 3 | 2 | 2 | 1 | 3 | 1 |
| ranking | | | | | | |

As shown in Table 2, the prints (i.e., the example printed liners) created on the example coated liners generally have improved mechability over the corresponding prints (i.e., the corresponding comparative example printed liners) created on the comparative example coated liners. Additionally, the improved mechability is observed in the print created from example coating composition E3 as compared to the print created from comparative coating composition C3 even though example coating composition E3 has a reduced amount of latex. The sum of the amount of polyvinyl alcohol and the latex in example coating composition E3 was equal to the sum of the amount of polyvinyl alcohol and the latex in comparative coating composition C3. Thus, example coating composition E3 and comparative coating composition C3 contained an equal amount of total binder materials. The improved mechability of the print created from example coating composition E3 as compared to the print created from comparative coating composition C3 demonstrates that the improved mechability is due to the increased amount of polyvinyl alcohol specifically rather than to an increased amount of binder generally.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range. For example, a range from about 1 dry wt % to about 21 dry wt % should be interpreted to include not only the explicitly recited limits of from about 1 dry wt % to about 21 dry wt %, but also to include individual values, such as 1.5 dry wt %, 8 dry wt %, 18.5 dry wt %, etc., and sub-ranges, such as from about 2 dry wt % to about 7 dry wt %, from about 4 dry wt % to about 6 dry wt %, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A coating composition for a packaging liner, comprising:
an inorganic pigment;
a latex;
polyvinyl alcohol in an amount ranging from greater than 2 dry wt % to about 7 dry wt %; and
a fixing agent selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof.

2. The coating composition as defined in claim 1 wherein:
the inorganic pigment is present in an amount ranging from about 75 dry wt % to about 85 dry wt %;
the latex is present in an amount ranging from about 5.5 dry wt % to about 8.5 dry wt %; and
the fixing agent is present in an amount ranging from about 1 dry wt % to about 21 dry wt %.

3. The coating composition as defined in claim 1, further comprising a surfactant/dispersant, a wax, a plastic pigment, a crosslinker, water, or a combination thereof.

4. The coating composition as defined in claim 1, further comprising a surfactant/dispersant, a wax, a plastic pigment, or combinations thereof, and wherein when included:
the surfactant/dispersant is present in an amount ranging from greater than 0 dry wt % to about 2 dry wt %;
the wax is present in an amount ranging from greater than 0 dry wt % to about 8.5 dry wt %; and
the plastic pigment is present in an amount ranging from greater than 0 dry wt % to about 8.5 dry wt %.

5. The coating composition as defined in claim 1 wherein the fixing agent is a non-polymeric salt.

6. The coating composition as defined in claim 1 wherein the inorganic pigment is selected from the group consisting of calcined clay, modified calcium carbonate, ground calcium carbonate, and combinations thereof.

7. The coating composition as defined in claim 1 wherein a ratio of the fixing agent to the polyvinyl alcohol ranges from about 1:2 to about 10:3.

8. A coated liner for corrugated packaging, comprising:
a base liner; and
an ink-receiving layer disposed on the base liner, the ink-receiving layer including:
an inorganic pigment;
a latex;
polyvinyl alcohol in an amount ranging from greater than 2 wt % to about 7 wt %, based on a total weight of the ink-receiving layer; and
a fixing agent selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof.

9. The coated liner as defined in claim 8 wherein:
the inorganic pigment is present in an amount ranging from about 75 wt % to about 85 wt %, based on the total weight of the ink-receiving layer;
the latex is present in an amount ranging from about 5.5 wt % to about 8.5 wt %, based on the total weight of the ink-receiving layer; and
the fixing agent is present in an amount ranging from about 1 wt % to about 21 wt %, based on the total weight of the ink-receiving layer.

10. The coated liner as defined in claim 8 wherein the base liner is a bleached liner.

11. A printing method for producing a printed liner, the method comprising printing a liquid ink on the ink-receiving layer of the coated liner of claim 8.

12. The method as defined in claim 11 wherein the printing of the liquid ink is accomplished at a printing speed up to 600 feet per minute (fpm).

13. A method for producing a coated liner for corrugated packaging, the method comprising:
applying a coating composition to a pulp of a base liner material, the coating composition including:
an inorganic pigment;
a latex;
polyvinyl alcohol in an amount ranging from greater than 2 dry wt % to about 7 dry wt %;
a fixing agent selected from the group consisting of water-soluble mono-valent metallic salts, water-soluble multi-valent metallic salts, and combinations thereof, wherein the metallic salt includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, chlorohydrate, and combinations thereof; and
water in an amount sufficient to render a total solids content of the coating composition ranging from about 50 wt % to about 65 wt %; and
drying the coating composition and the pulp to form the coated liner.

14. The method as defined in claim 13 wherein the applying of the coating composition is accomplished at a coating speed up to 3000 feet per minute (fpm).

15. The method as defined in claim 13 wherein a coat weight of the applied and dried coating composition ranges from about 5 grams per square meter (gsm) to about 30 grams per square meter (gsm).
